(19) United States
(12) Patent Application Publication
(10) Pub. No.: US 2005/0150091 A1
(43) Pub. Date: Jul. 14, 2005

(54) Sculpted three-dimensional cap panel

(76) Inventors: Daniel J. Parker, Connersville, IN (US); Jamie D. Riddle, Sunman, IN (US); Greg Wray, Guilford, IN (US)

Correspondence Address: WOOD, HERRON & EVANS, LLP, 2700 CAREW TOWER, 441 VINE STREET, CINCINNATI, OH, 45202, US

(21) Appl. No.: 10/757,050

(22) Filed: Jan. 14, 2004

(51) Int. Cl. A61G 17/00

(52) U.S. Cl. 27/19

(57) ABSTRACT

A cap panel or cap panel insert and methods of making the same having three-dimensional aspects to enhance the aesthetic appearance is hereby provided. A cast paper product is used for the various three-dimensional designs in or on the cap panel or cap panel insert. In particular, a three-dimensional design may be formed integral to the cap panel or cap panel insert through a molding process that provides a wide variety of sculpted shapes that can be tailored to meet the specific desires of a family to reflect a particular feature or trait of the deceased. The cast paper cap panel or cap panel insert can be integrated into a dish assembly to provide the decorative aspects of a burial casket lid during a showing.

### FIELD OF THE INVENTION

The present invention relates generally to burial caskets, and more particularly to cap panels for burial casket caps or lids.

### BACKGROUND OF THE INVENTION

Burial caskets traditionally comprise a shell to which is pivoted a cap or lid. During viewing of the deceased in the casket, the cap is of course pivoted to its open position to permit relatives, loved ones, acquaintances and the like to view the deceased. During this time the underside of the casket cap is visible. It is thus desirable to trim the underside of the cap with decorative trim. This has been traditionally accomplished with the installation of a dish assembly into the underside of the cap.

The traditional dish assembly has taken the form of a rectangular cap panel having two long sides and two short sides, with a puffing member being attached to each of the four sides. The cap panel is positioned in the casket cap atop a standoff, itself positioned in the cap, or atop a ridge or groove forming a part of the cap. The free edges of the puffing members are retained in a peripheral groove in the casket cap near the peripheral edge of the cap. The puffing members are so sized as to require them to assume a convex shape for their free edges to be retained in the peripheral groove. The cap panel is a generally planar surface that is covered with decorative fabric that typically matches the design and fabric of the puffing members to provide an aesthetically pleasing appearance. To enhance the overall appearance of the dish assembly, some type of embroidered or other decorative design might be sewn into the fabric covering the cap panel.

In many cases, it is desirable to have dish assemblies with a wide variety of fabric colors and designs to choose from. To allow for a quick and convenient method of changing the look of the dish assembly, the dish assembly may further include a rectangular generally planar cap panel insert installed between the four puffing members and in juxtaposition relative to the cap panel such that the cap panel insert and the puffing members now make up the decorative aspect of the dish assembly. In this way, when one wants to change the design of the dish assembly, the cap panel insert may be interchanged with one of a different design to effectuate the desires of the deceased's family.

Moreover, it is desirable to employ a means of attachment which permits removable securement of the cap panel insert into the dish assembly to allow various inserts to be readily presented to a purchaser of the casket. Quite often, a customer will desire to view a number of different inserts in a dish assembly during the casket selection process, with each insert having a different embroidered pattern, or different fabric, thereon. Therefore it is desirable to be able to quickly remove one cap panel insert from the dish assembly of a casket cap and to replace it with another insert for selection purposes.

Various means may be provided to secure the cap panel insert into the dish assembly, including for example, by friction fit or by retaining tabs mounted to the cap panel such as that disclosed by U.S. Pat. No. 5,675,877 issued to Lewis, assigned to the assignee of the present invention, and incorporated by reference herein. Lewis discloses using hook and loop type fasteners, such as VELCRO®, adhered to the cap panel and the generally planar cap panel insert to removably secure the cap panel insert to the cap panel.

Another technique for removably installing a cap panel insert into a dish assembly is disclosed in Winburn et al. U.S. Pat. No. 4,357,741, assigned to the assignee of the present invention, and incorporated by reference herein. The Winburn patent discloses the use of a pair of elongated straps secured to a generally planar cap panel insert to facilitate installation of the insert into the dish assembly. The straps are spaced along the length of the insert and are fixedly or permanently secured to the insert near the lower ends of the straps. Near the upper ends of the straps the straps are removably secured to the insert via fasteners. The straps are longer than the height of the insert so that a portion of each strap protrudes above and below the top and bottom edges of the insert. To install the insert into a dish assembly, the bottom strap portions are inserted between the cap panel and the bottom puffing. The insert is angled outwardly from the cap, i.e. toward an installer, during which time the upper ends of the straps are not connected to the insert, and the top strap portions are inserted between the cap panel and the top puffing. The straps are flexible enough to allow bowing of the straps to slip the top strap portions into place. The insert is then pivoted into place against the cap panel and the fasteners attached to the insert are fastened to the fasteners attached near the upper ends of the straps.

It is therefore desirable to provide a cap panel insert for a casket dish assembly which is aesthetically appealing and which is a departure from the traditional generally planar cap panel insert. It is also desirable to provide a dish assembly for a burial casket cap of improved construction and aesthetics which provides quick and easy installation and removal of the cap panel insert into and from the dish assembly and positive retention of the insert in the assembly.

### SUMMARY OF THE INVENTION

The present invention provides a cap panel or cap panel insert of a dish assembly of a burial casket cap having three-dimensional aspects to enhance the aesthetic appearance during the viewing of the deceased. The present invention utilizes cast paper to form the various three-dimensional designs in the cap panel or cap panel insert. In one embodiment, a cap panel is formed from cast paper and configured into a three-dimensional design. The cast paper cap panel may be molded wherein the mold provides various three-dimensional designs integral to the cap panel. The three-dimensional design in the cap panel can comprise many forms including for example, a bas-relief having a wide variety of sculpted shapes formed therein that can be tailored to meet the specific desires of the family so as to reflect a particular feature or trait of the deceased. Moreover, cast paper materials are advantageous in providing a textured aspect to enhance aesthetic appeal.

In another embodiment, a cap panel insert for overlying at least a portion of a cap panel is formed from cast paper and configured into a three-dimensional design. The cast paper cap panel insert may be molded wherein the mold provides various three-dimensional designs integral to the cap panel insert. Alternatively, the cap panel insert can be comprised of a generally planar first portion with a cast paper three-dimensional second portion attached to the planar first portion. As with the cap panel, the three-dimensional design in the cap panel insert may comprise many forms including for example, a bas-relief having a wide variety of sculpted shapes formed therein. The cast paper further provides a textured look to the cap panel insert.

The present invention also provides a dish assembly comprising a generally rectangular cap panel having a pair of opposed shorter sides and a pair of opposed longer sides, and puffing members attached to each side of the cap panel. The cap panel is configured into a three-dimensional design of the above construction.

The present invention also provides a dish assembly comprising a generally rectangular cap panel having a pair of opposed shorter sides and a pair of opposed longer sides, puffing members attached to each side, and a cast paper cap panel insert removably inserted between the puffing members and juxtaposed relative to the cap panel where the cap panel insert is configured into a three-dimensional design of the above construction.

The present invention further provides a one-piece dish assembly comprising a generally rectangular cap panel and puffing members formed integral with each other, and a cast paper cap panel insert removably coupled to the cap panel where the cap panel insert is configured into a three-dimensional design of the above construction.

The present invention also provides a burial casket comprising a shell and a cap pivoted to the shell with the cap including a dish assembly of the above construction.

The present invention also provides a method of making a cast paper cap panel or cap panel insert for a dish assembly of a burial casket cap. The method comprises the steps of chopping cotton fibers into small pieces, mixing the cotton fiber pieces with water to form a watery pulp, pressing the pulp in a mold having a desired three-dimensional design, blotting up any excess water, leaving the molded cast paper in the mold to air dry, and pulling the dried piece from the mold to provide a cast paper cap panel or cap panel insert configured into a three-dimensional design.

The main advantage of the present invention is that a cap panel or a cap panel insert may be aesthetically enhanced by configuring it into a three-dimensional design. Cast paper can be easily molded into a wide variety of designs that provide greater decorative options when selecting a burial casket. The enhancing three-dimensional designs in the cap panel or cap panel insert may be readily incorporated into dish assemblies traditionally used to decorate burial casket lids.

These and other objects and advantages of the present invention will become more readily apparent during the following detailed description taken in conjunction with the drawings herein.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is a perspective view of a burial casket incorporating a dish assembly having a three-dimensional design according to the principles of the present invention;

FIG. 2 is a side elevation view of the burial casket lid of FIG. 1 along line 2-2 showing the cap panel configured into a three-dimensional design;

FIG. 3 is a side elevation view of a burial casket lid similar to FIG. 2 showing the cap panel insert configured into a three-dimensional design;

FIG. 4 is a side elevation view of a burial casket lid similar to FIG. 3 showing a planar cap panel insert having a three-dimensional design coupled to the cap panel insert;

FIG. 5 is a perspective view of a one-piece dish assembly having a cap panel insert configured into a three-dimensional design; and

FIGS. 6A-B are sequential side elevation views of the cast paper being molded into a cap panel or cap panel insert having a three-dimensional design.

### DETAILED DESCRIPTION

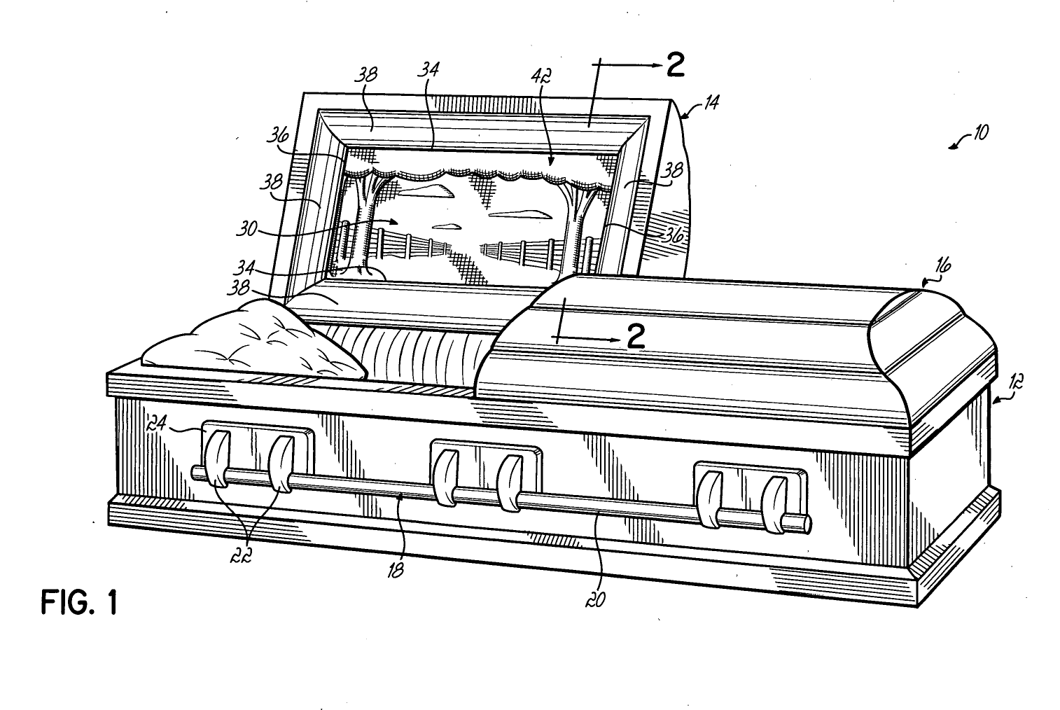

Referring first to FIG. 1, there is illustrated a casket incorporating the principles of the present invention. The casket 10 includes a shell 12 to which is pivoted a head end cap 14 and a foot end cap 16. The caps 14 and 16 are pivoted to the shell 12 by conventional means known to those skilled in the art, but not shown in the drawings. Hardware 18 in the form of a handlebar 20 is supported by arms 22 attached to escutcheon plates 24 which are in turn attached to the shell 12. The caps 14 and 16 each include a dish assembly 30 mounted on the underside thereof (only visible in the head end cap 14 of FIG. 1).

The dish assembly 30 generally includes an insert or cap panel 32 and a series of puffing members 38 attached thereto that give the dish assembly 30 a recessed, picture-frame look, and optionally, a cap panel insert 40 overlying the cap panel 32 such that the cap panel insert 40 and the puffing members 38 now make up the decorative aspects of the dish assembly 30. The cap panel 32 or the cap panel insert 40 may be configured into a three-dimensional design to provide a more aesthetically pleasing appearance, as will be subsequently described.

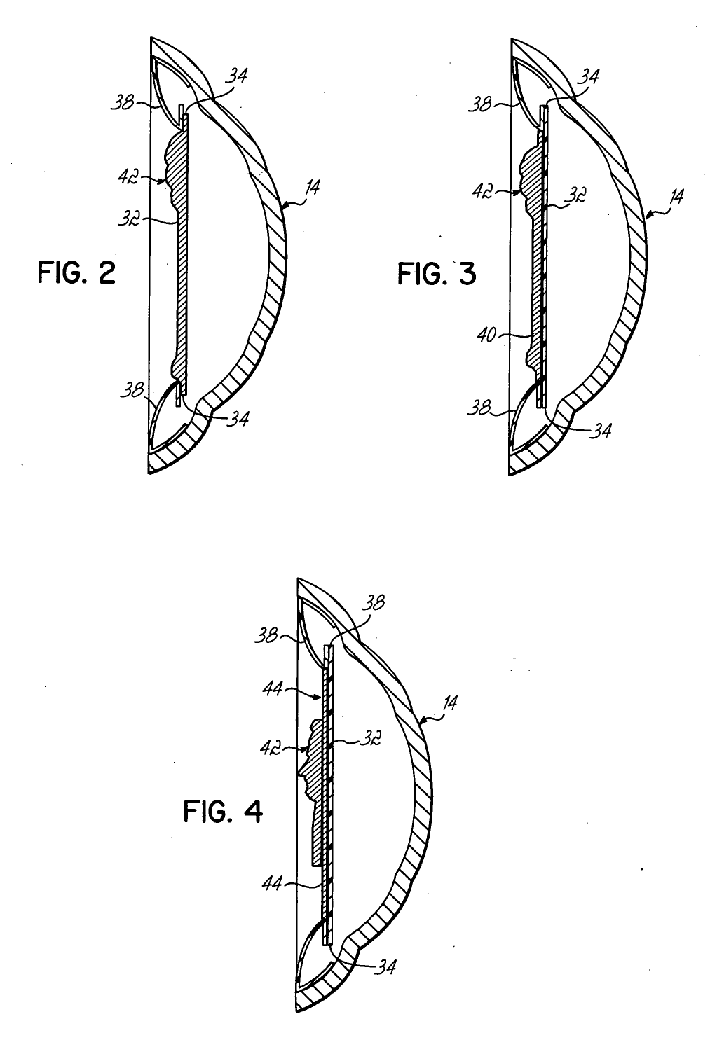

As shown in FIGS. 1 and 2, one embodiment of the present invention has a dish assembly 30 with a generally rectangular cap panel 32 having a pair of opposed longer sides 34 and a pair of opposed shorter sides 36. A puffing member 38 is attached to each longer side 34 and to each shorter side 36 adjacent their respective edges of cap panel 32. The cap panel 32 is configured to have a three-dimensional design 42 that may, for example, be a bas-relief or some other design that has a three-dimensional aspect. The present invention provides for a virtually limitless number of three-dimensional designs that may be incorporated into the cap panel. The three-dimensional design 42 may be directly incorporated or formed integral within the cap panel 32, by for example, a molding process.

As shown in FIG. 3, another embodiment of the present invention is to incorporate the three dimensional design into a cap panel insert 40 that overlies a traditional planar cap panel 32. A generally rectangular cap panel insert 40 having a pair of opposed longer and shorter sides corresponding to longer and shorter opposed sides 34 and 36 of the cap panel is inserted between the puffing members 38 and juxtaposed relative to the cap panel 32. The cap panel insert 40 is configured to have a three-dimensional design 42 that may, for example, be a bas-relief or some other design that has a three-dimensional aspect. Again, the present invention provides for a virtually limitless number of three-dimensional designs 42 that may be incorporated into the cap panel insert 40. The three-dimensional design 42 may be directly incorporated or formed integral within the cap panel insert 40, by for example, a molding process.

Alternatively, and as shown in FIG. 4, the three-dimensional aspect of the cap panel insert 40 may be achieved by combining a generally planar first portion 44 with a separate three-dimensional second portion 42 coupled to the first portion 44. This might occur, for example, as a modification to the generally planar cap panel inserts currently used in burial casket dish assemblies. By incorporating the three-dimensional aspects of the second portion 42 into the cap panel insert 40, the designs may be quickly and conveniently changed to provide a greater selection and pose various options when selecting a burial casket.

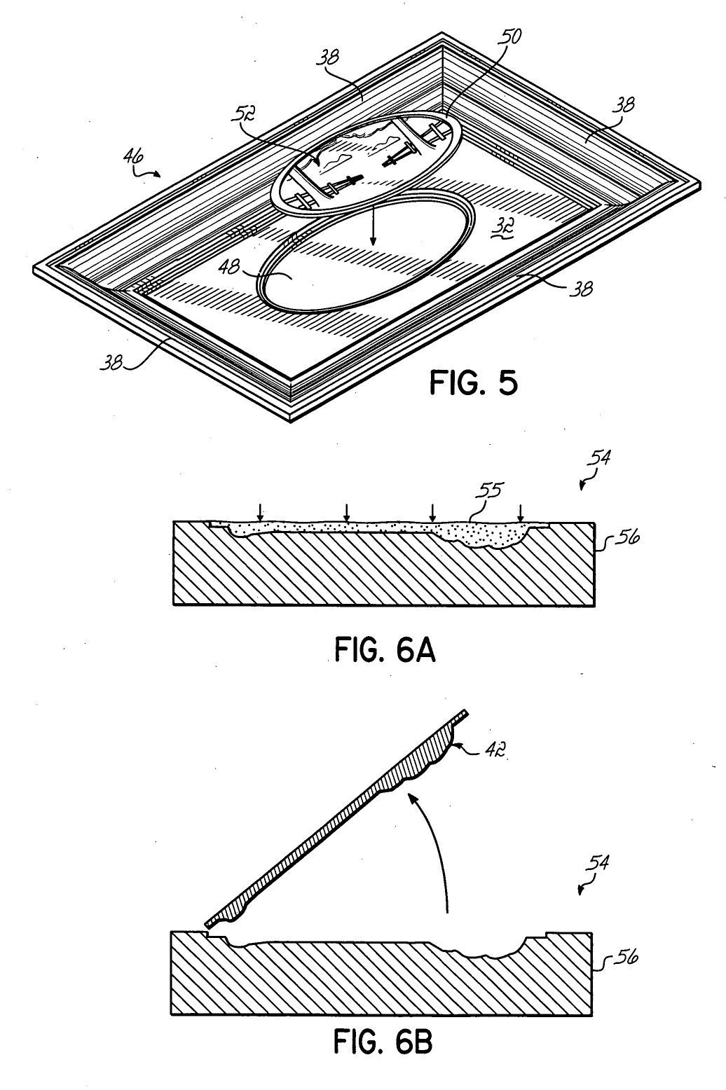

FIG. 5 shows a one-piece dish assembly 46 where the cap panel 32 and the puffing members 38 are formed integral with each other to form a single unitary structure. The one-piece assembly may be formed out of thermoplastic materials or other suitable materials known to those in the art through known molding processes. The one-piece assembly 46 includes an oval recess 48 for receiving an oval-shaped cap panel insert 50. The cap panel insert 50 is configured to have a three-dimensional design 52 that may, for example, be a bas-relief or some other design that has a three-dimensional aspect. The three-dimensional design 52 may be directly incorporated or formed integral within the cap panel insert 50, by for example, a molding process. The cap panel insert 50 fits within the oval recess 48 and is coupled to the dish assembly 46 through known methods, such as by an adhesive.

The embodiments of the present invention having the cap panel 32 or the cap panel inserts 40, 50 configured into a three-dimensional design 42 formed integral to the cap panel or cap panel insert are made from cast paper product. Moreover, in the embodiment of FIG. 4, the cap panel insert 40 having a generally planar surface 44 with a three-dimensional design 42 coupled to the planar surface, the three-dimensional design 42 is formed from cast paper. Preferably, cast paper is a combination of cotton fibers, mixed with water and perhaps other additives in proportions such that given a sufficient amount of time to dry or cure, forms a hardened material.

As shown in FIGS. 6A-B, the three-dimensional designs of the present invention may be formed by molding the cast paper. FIG. 6A shows a mold generally depicted by 54 having a bottom mold plate 56. The mold plate 56 has various protrusions and recesses that define a three-dimensional design. To make a cast paper cap panel 32 or cap panel inserts 40, 50, cotton fibers are chopped into small pieces and thoroughly mixed with water to form a watery pulp 55. The amount of cotton fibers and water will depend on the size of the cap panel or cap panel insert desired. The pulp 55 is applied to a surface of bottom mold 56 so as to have a generally uniform layer of pulp. The pulp 55 is then pressed into the mold, such as by using a towel (not shown) and applying sufficient pressure, typically less than approximately 30 psi, to push the pulp firmly into the recesses of the mold. The towel may also be used to blot up any excess water. The now molded pulp 55 remains on the bottom mold 56 and left to air dry. As shown in FIG. 6B, upon complete drying, the cast paper cap panel 32 or cap panel insert 40, 50 is pulled from the mold 56 and is ready to be assembled into the dish assembly 30, 46 of the burial casket 10.

While the present invention has been illustrated by the description of the various embodiments thereof, and while the embodiments have been described in considerable detail, it is not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicant's general inventive concept.

1. A cast paper cap panel for a dish assembly of a burial casket cap, said cap panel configured into a three-dimensional design.

2. The cap panel of claim 1 wherein said cap panel is rectangular with a pair of opposed shorter sides and a pair of opposed longer sides.

3. The cap panel of claim 1 wherein said three-dimensional design is molded in said cap panel.

4. The cap panel of claim 1 wherein said three-dimensional design in said cap panel comprises a bas-relief.

5. The cap panel of claim 1 wherein said cap panel is textured.

6. A cast paper cap panel insert for overlying at least a portion of a cap panel of a dish assembly of a burial casket cap, said cap panel insert configured into a three-dimensional design.

7. The cap panel insert of claim 6 wherein said cap panel insert is rectangular with a pair of opposed shorter sides and a pair of opposed longer sides.

8. The cap panel insert of claim 6 wherein said cap panel insert is oval.

9. The cap panel insert of claim 6 wherein said three-dimensional design is molded in said cap panel insert.

10. The cap panel insert of claim 6 wherein said three-dimensional design in said cap panel insert comprises a bas-relief.

11. The cap panel insert of claim 6 wherein said cap panel insert is textured.

12. A cap panel insert for overlying at least a portion of a cap panel of a dish assembly of a burial casket cap, said cap panel insert comprising a generally planar first portion and a three-dimensional cast paper second portion attached to said first portion.

13. The cap panel insert of claim 12 wherein said cap panel insert is rectangular with a pair of opposed shorter sides and a pair of opposed longer sides.

14. The cap panel insert of claim 12 wherein said three-dimensional design is molded in said cap panel insert.

15. The cap panel insert of claim 12 wherein said three-dimensional design in said cap panel insert comprises a bas-relief.

16. The cap panel insert of claim 12 wherein said cap panel insert is textured.

17. A dish assembly for a burial casket cap comprising:
a generally rectangular cast paper cap panel having a pair of opposed shorter sides and a pair of opposed longer sides; and
a puffing member attached to each said side;
said cap panel configured into a three-dimensional design.

18. The cap panel of claim 17 wherein said three-dimensional design is molded in said cap panel.

19. The cap panel of claim. 17 wherein said three-dimensional design in said cap panel comprises a bas-relief.

20. The cap panel of claim 17 wherein said cap panel is textured.

21. A dish assembly for a burial casket cap comprising:
a generally rectangular cap panel having a pair of opposed shorter sides and a pair of opposed longer sides;
a puffing member attached to each said side;
a cast paper cap panel insert removably inserted between said puffing members and juxtaposed relative to said cap panel, said cap panel insert configured into a three-dimensional design.

22. The cap panel insert of claim 21 wherein said cap panel insert is rectangular with a pair of opposed shorter sides and a pair of opposed longer sides.

23. The cap panel insert of claim 21 wherein said three-dimensional design is molded in said cap panel insert.

24. The cap panel insert of claim 21 wherein said three-dimensional design in said cap panel insert comprises a bas-relief.

25. The cap panel insert of claim 21 wherein said cap panel insert is textured.

26. A dish assembly for a burial casket cap comprising:
a generally rectangular cap panel having a pair of opposed shorter sides and a pair of opposed longer sides;
a puffing member attached to each said side;
a cap panel insert removably inserted between said puffing members and juxtaposed relative to said cap panel, said cap panel insert comprising a generally planar first portion and a three-dimensional cast paper second portion attached to said first portion.

27. The cap panel insert of claim 26 wherein said cap panel insert is rectangular with a pair of opposed shorter sides and a pair of opposed longer sides.

28. The cap panel insert of claim 26 wherein said three-dimensional design is molded in said cap panel insert.

29. The cap panel insert of claim 26 wherein said three-dimensional design in said cap panel insert comprises a bas-relief.

30. The cap panel insert of claim 26 wherein said cap panel insert is textured.

31. A dish assembly for a burial casket cap comprising:
a generally rectangular cap panel having a pair of opposed shorter sides and a pair of opposed longer sides;
a puffing member attached to each said side, said cap panel and said puffing members formed integral with each other to form a unitary structure;
a cast paper cap panel insert removably coupled to said cap panel, said cap panel insert configured into a three-dimensional design.

32. The cap panel insert of claim 31 wherein said cap panel insert is oval.

33. The cap panel insert of claim 31 wherein said three-dimensional design is molded in said cap panel insert.

34. The cap panel insert of claim 31 wherein said three-dimensional design in said cap panel insert comprises a bas-relief.

35. The cap panel insert of claim 31 wherein said cap panel insert is textured.

36. A burial casket comprising:
a shell;
a cap pivoted to said shell; and
a dish assembly positioned into an underside of said cap, said dish assembly comprising:
a generally rectangular cast paper cap panel having a pair of opposed shorter sides and a pair of opposed longer sides; and
a puffing member attached to each said side;
said cap panel configured into a three-dimensional design.

37. The cap panel of claim 36 wherein said three-dimensional design is molded in said cap panel.

38. The cap panel of claim 36 wherein said three-dimensional design in said cap panel comprises a bas-relief.

39. The cap panel of claim 36 wherein said cap panel is textured.

40. A burial casket comprising:
a shell;
a cap pivoted to said shell; and
a dish assembly positioned into an underside of said cap, said dish assembly comprising:
a generally rectangular cap panel having a pair of opposed shorter sides and a pair of opposed longer sides;
a puffing member attached to each said side;
a cast paper cap panel insert removably inserted between said puffing members and juxtaposed relative to said cap panel, said cap panel insert configured into a three-dimensional design.

41. The cap panel insert of claim 40 wherein said cap panel insert is rectangular with a pair of opposed shorter sides and a pair of opposed longer sides.

42. The cap panel insert of claim 40 wherein said three-dimensional design is molded in said cap panel insert.

43. The cap panel insert of claim 40 wherein said three-dimensional design in said cap panel insert comprises a bas-relief.

44. The cap panel insert of claim 40 wherein said cap panel insert is textured.

45. A burial casket comprising:
a shell;
a cap pivoted to said shell; and
a dish assembly positioned into an underside of said cap, said dish assembly comprising:
a generally rectangular cap panel having a pair of opposed shorter sides and a pair of opposed longer sides;
a puffing member attached to each said side;
a cap panel insert removably inserted between said puffing members and juxtaposed relative to said cap panel, said cap panel insert comprising a generally planar first portion and a three-dimensional cast paper second portion attached to said first portion.

46. The cap panel insert of claim 45 wherein said cap panel insert is rectangular with a pair of opposed shorter sides and a pair of opposed longer sides.

47. The cap panel insert of claim 45 wherein said three-dimensional design is molded in said cap panel insert.

48. The cap panel insert of claim 45 wherein said three-dimensional design in said cap panel insert comprises a bas-relief.

49. The cap panel insert of claim 45 wherein said cap panel insert is textured.

50. A burial casket comprising:
a shell;
a cap pivoted to said shell; and
a dish assembly positioned into an underside of said cap, said dish assembly comprising:
a generally rectangular cap panel having a pair of opposed shorter sides and a pair of opposed longer sides;
a puffing member attached to each said side, said cap panel and said puffing members formed integral with each other to form a unitary structure; and,
a cast paper cap panel insert removably coupled to said cap panel, said cap panel insert configured into a three-dimensional design.

51. The cap panel insert of claim 50 wherein said cap panel insert is oval.

52. The cap panel insert of claim 50 wherein said three-dimensional design is molded in said cap panel insert.

53. The cap panel insert of claim 50 wherein said three-dimensional design in said cap panel insert comprises a bas-relief.

54. The cap panel insert of claim 50 wherein said cap panel insert is textured.

55. A method of making at least one of a cap panel and cap panel insert configured into a three-dimensional design comprising:
chopping a supply of cotton fibers into small pieces;
mixing the cotton fibers with water to form a pulp;
pressing the pulp into a mold having a three-dimensional design formed therein; and,
drying the molded pulp;

56. The method of claim 55 further comprising blotting excess water off the molded cast paper.

57. The method of claim 55 wherein the step of drying the molded cast paper comprises leaving the cast paper on the mold to air dry.

58. The method of claim 55 wherein the step of pressing the pulp into a mold comprises pressing the pulp into a mold at a pressure of less than 30 psi.
